(19) United States
(12) Patent Application Publication
(10) Pub. No.: US 2020/0404163 A1
(43) Pub. Date: Dec. 24, 2020

(54) A System for Presenting and Identifying Markers of a Variable Geometrical Image

(71) Applicant: Ars Electronica Linz GmbH & Co KG, Linz (AT)

(72) Inventor: Horst HÖRTNER, Kleinzell (AT)

(21) Appl. No.: 16/969,670

(22) PCT Filed: Feb. 12, 2019
(86) PCT No.: PCT/AT2019/060050

§ 371 Date: Aug. 13, 2020

(30) Foreign Application Priority Data
Feb. 13, 2018 (AT) GM 50026/2018

(51) Int. Cl. H04N 5/232; G06T 7/73; G05D 1/00; G05D 1/10

(52) U.S. Cl. CPC H04N 5/23218; H04N 5/23229; G06T 7/74; H04M 1/725; G05D 1/104; G06T 2207/30244; G06T 2207/30204; G05D 1/0027

(57) ABSTRACT

A system for presenting and identifying markers of a geometrical image within space, having at least one portable device with a shooting unit and an electronic data processing unit.

The markers are configured as dynamic markers of a geometrical image variable in terrestrial space and the system has at least three vehicles for forming the dynamic markers, wherein each vehicle is configured to be autonomously moved within space by means of a control unit, wherein the control unit of at least one vehicle is configured to move the vehicle from a first marker position of a first image to a second marker position of a second image, wherein the data processing unit is configured to output the shots processed by way of the identified dynamic markers of the first image, of the second image, and optionally of all intermediate images that may be shot according to a shooting speed of the shooting unit, to a display means of the system.

The invention relates to a system for identifying markers of a geometrical image within space, having at least one portable device with a shooting unit, which is configured to shoot the image, and an electronic data processing unit, which is configured to identify the markers and to process the shots by way of the identified markers.

The US 2006/0235614 A1 discloses a device known from prior art and a method for identifying celestial bodies. Using the device, there may be generated, for example, digital images of the night sky. Thereby, distinctive light points, in particular celestial bodies, are registered as markers and compared, by way of their geometrical relationship with one another, with images stored in a data base. Celestial bodies may thus be identified and outputted via a display to a user. A disadvantage of the device is, among others, that in the case of a falsely determined orientation, there may be acquired a false result.

Similar methods may be performed with the aid of a software product for smart phones, wherein herein there are commonly not shot any images of the night sky but rather the celestial bodies stored in a data base are outputted on a display of the smart phone, in dependency of the geographical position and the orientation of the smart phone. One disadvantage of these methods is, among others, that in the case of a falsely determined position and/or orientation, there will be inevitably displayed a false result.

The biggest disadvantage of the devices and methods known from prior art, however, is that these are limited to the identification and presentation of celestial bodies. This, on the one side, will limit their usability for commercial purposes and, on the other side, their benefit for potential users.

The objective of the invention is to provide an improved system for presenting and identifying markers of a geometrical image within space, which reduces the disadvantages known from prior art and in particular improves the commercial usability and the benefit for potential users.

According to the invention, this task is solved by the provision of a system for presenting and identifying markers of a geometrical figure within space, wherein the markers are configured as dynamic markers of a geometrical figure variable within terrestrial space and that the system has at least three vehicles for forming the dynamic markers, wherein each vehicle is configured to be autonomously moved within space by means of a control unit, wherein the control unit of at least one vehicle is configured to move the vehicle from a first marker position of a first image to a second marker position of a second image, wherein the data processing unit is configured to output, by way of the identified markers, the processed shots of the first image, of the second image and optionally of all intermediate images that may be shot according to a shooting speed of the shooting unit to a display means of the system.

The system according to the invention advantageously enables the presentation and identification of dynamic images on the Earth surface and/or airspace near Earth. As the markers may be configured to be dynamic by the vehicles of the system, the position and formation thereof within space, and as a consequence the image itself, may be varied in any way as well as dynamically. The system according to the invention may, as a consequence, not only be advantageously used for celestial bodies but rather the commercial usability and the benefit for potential users will be significantly increased. Furthermore, the system according to the invention makes it possible to determine and to process a plurality of additional information items, which may be derived, on the one side, from the movement of the vehicles, this is, the movement of the markers, and, on the other side, from the movement and perspective of the users. In particular if the embodiment of the software on the end device of the user communicates this information (position, movement, utilization etc.) to a data collection centre (such as the control centre or an internet data base within the “cloud”, etc.). These precise momentary images on the distribution of the users within a geographical area may be further used wisely in order to, for example, plan a concrete emergency operation in the case of an emergency (date and site of the potentially endangered user is known). Via this data collection, there is enabled a plurality of further data utilization models such as, for example, “crowd management”, specified provision to the users of information suitable for the position and situation thereof, and many more.

In an advantageous embodiment of the invention the data processing unit of the portable device, when processing the shots, is configured to superimpose, combine and/or replace the images, in particular the identified dynamic markers, with pre-defined, in particular dynamic and/or three-dimensional, graphical elements, wherein the graphical elements are located on a storage unit of the portable device and/or are transmitted by means of a communication unit of the transportable device to the data processing unit, and wherein the data processing unit is configured to output the shots thus processed to the display means of the system. The images presented on the display means of the system may in this way be advantageously varied and/or expanded.

In a further advantageous embodiment of the invention the system has a control centre, wherein the control centre is configured to control the control units of the vehicles, wherein the vehicles and the control centre have communication units for the mutual communication. The dynamic markers and, in consequence, also the variable geometrical image may thus be centrally controlled by the control centre and optionally varied in real time. For this purpose, the control centre may additionally have a user interface.

The control centre is preferably configured to transmit the graphical elements to the portable device. The images presented on the display means may in this way be centrally controlled and optionally varied by the control centre.

In an advantageous embodiment of the invention the data processing unit of the portable device is configured, by way of the identified dynamic markers and at least one reference image, to determine the position of the portable device within space in relation to a reference position of the system and to adjust the processing of the shots according to the determined position of the portable device, wherein the reference image is located on a storage unit of the portable device and/or transmitted from the control centre to the data processing unit. The images displayed on the display means of the system may in this way be advantageously adjusted to the position of the portable device, for example, in order to take into consideration the perspective of a user using the portable device in regard to the vehicles, this is in regard to the dynamic image within space.

The portable device preferably has the display means and is configured as a device for telecommunication, in particular as a smart phone, and/or as a device for the presentation of virtual reality contents or augmented reality contents, in particular as VR goggles or AR goggles. The images displayed on the display means of the system may in this way be advantageously displayed, in particular in a VR surrounding or AR surrounding, directly for a user holding the portable device, wherein, for example, also the perspective of the user in regard to the vehicle, this is in regard to the dynamic image within space, may be taken into consideration.

Preferably at least one of the vehicles has a vehicle equipment, selected from the following group: unmanned aircraft, in particular a drone, a balloon or an airship, unmanned water vehicle, in particular a water drone, a submarine drone or a marine buoy, unmanned land vehicle, in particular a robot vehicle. In this way, by means of the vehicles, this is by means of the dynamic markers, all possible images on the earth surface and/or in airspace near Earth may be presented.

In a further advantageous embodiment the data processing unit of the portable device is configured to compare the shots, in particular the identified dynamic markers, and/or the processed shots of an image with a general reference image and/or with individualized reference images, in particular individualized codes, wherein the general reference image and/or the individualized reference images are located on a storage unit of the portable device and/or are transmitted by means of the communication unit of the portable device to the data processing unit. The shots of the dynamic images may, for example, in this way trigger individualized presentations on the display means of the system for the user, after they have been compared with the general and/or individualized reference image.

In a further advantageous embodiment, the portable device is configured, by means of a user interface, to control the control units of the vehicles, wherein the communication unit of the portable device is configured for the unilateral and/or mutual communication with the communication unit/s of the vehicles and/or the control centre. A user of the portable device may in this way, for example, via the internet or a local wireless network of the system, enter inputs, this is transmit commands in order to control the vehicles, this is the dynamic markers, by means of these commands. In this way, among others, there is developed a “feedback loop” between the image, this is the display of the markers, and the user/s. As an example, there may be performed a coordination on the real facts by all users of the portable devices located within the range of operation of the system and/or from where the markers are visible. This form of application is especially suitable for interactive narrations, for example, an augmented reality theatre play with audience interaction, or the transfer of additional information regarding concert events, sports events or events in public space, in which a plurality of people is present on site, often also with a certain viewing direction. The vehicles within the field of vision of the users/visitors allow for the development of a completely new interactive and participative communication medium with the people present on site.

The task described above is solved by means of the invention also by the fact that there is provided a method for the presentation and identification of markers of a geometrical image within space, wherein the markers are configured as dynamic markers of vehicles that are autonomously movable within space, with the following method steps being carried out:

A) controlling at least three vehicles to respectively one first marker position of a first image by means of a control unit of the vehicle;

B) controlling at least one of the vehicles to a second marker position of a second image by means of the control unit;

C) during the method steps A) and B), shooting the first image, the second image and optionally all intermediate images that may be shot according to a shooting speed of the shooting unit, by means of the shooting unit;

D) during and/or after the method step C), identifying the dynamic markers and processing the shots by way of the identified dynamic markers by means of the data processing unit;

F) outputting the shots processed to a display means by means of the data processing unit.

Preferably in a method step E), during and/or after the method step D), the processed shots, in particular the identified dynamic markers, are superimposed, combined and/or replaced by means of the data processing unit with pre-defined, in particular dynamic, graphical elements, wherein the graphical elements are located on a storage unit of the portable device and/or transmitted by means of a communication unit of the portable device.

The invention further claims a software product, which causes a data processing unit of a portable device in a system according to the invention to perform the method steps D), E) and F) of the method according to the invention.

The software product is preferably located on a storage unit of the portable device.

Further exemplary embodiments of the invention are described by way of the following figures. In a schematic depiction:

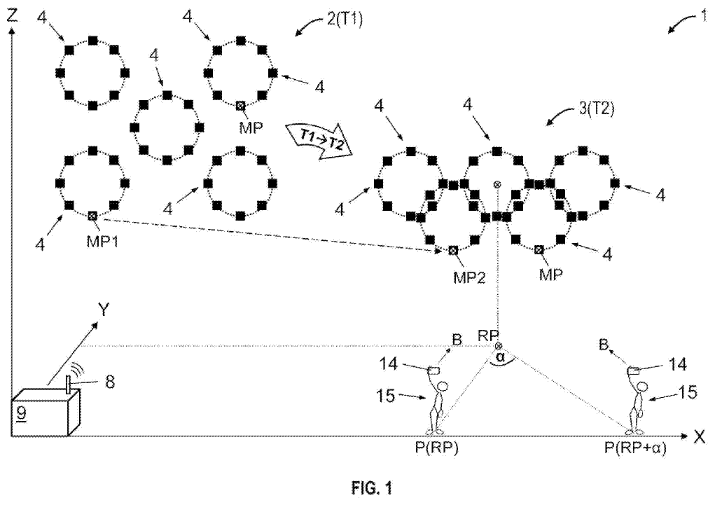

FIG. 1 shows an inventive system according to a first exemplary embodiment;

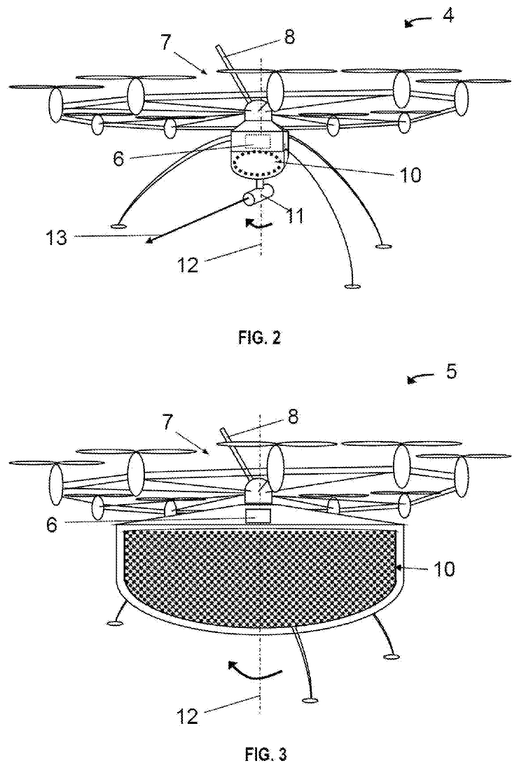

FIG. 2 shows a vehicle of a system according to the invention, wherein the vehicle has a first vehicle equipment as an unmanned aircraft;

FIG. 3 shows a vehicle of a system according to the invention, wherein the vehicle has a second vehicle equipment as an unmanned aircraft;

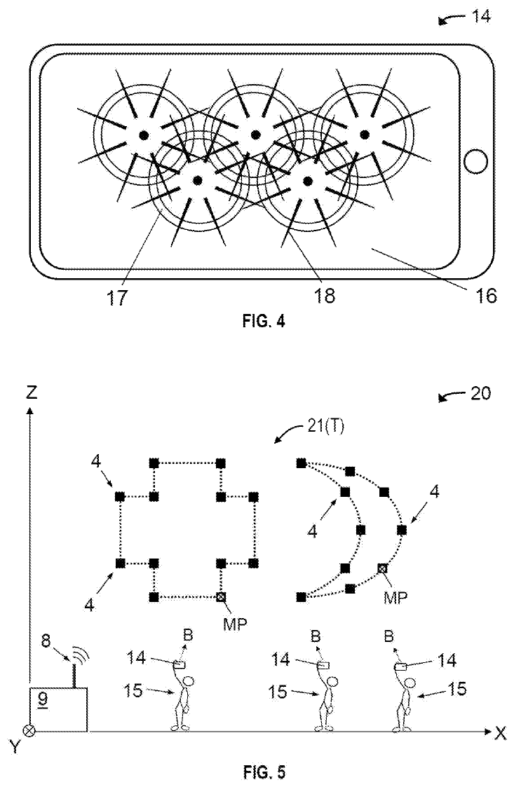

FIG. 4 shows a portable device of a system according to the invention, wherein the portable device as an example is configured as a smart phone;

FIG. 5 shows an inventive system according to a second exemplary embodiment.

FIG. 1 shows an inventive system 1 for the presentation and identification of dynamic markers of a variable geometrical image 2 or 3 within space, wherein the space is depicted via the spatial axes X, Y and Z. The image 2 is depicted at a first point in time T1, and the image 3 is depicted at a second point in time T2. The image 2 at the first point in time T1 is, in consequence of the application of the system 1, transferred to the image 3 at the second point in time T2.

“Space” means in connection with the following description exclusively the terrestrial space, which includes the Earth surface above/under water and on the ground as well as the airspace near Earth, essentially the established flight height. The dynamic markers or the variable geometrical image 2 or 3, respectively, may consequently be depicted on/in the water, on the ground and/or in the air.

A system according to the invention has at least three vehicles for forming the dynamic markers. In this way, it is possible to identify and depict a geometrical relationship of the vehicles to one another within space in a unique way. Alternatively, the vehicles of a system according to the invention may have any possible number of more than three.

FIG. 2 shows a vehicle 4 according to a first embodiment, and FIG. 3 shows a vehicle 5 according to a second embodiment, wherein the vehicles 4 and 5 may be utilized in the system 1 according to the invention. The vehicles 4 and 5 are configured as an unmanned aircraft, which is usually designated as a drone. Alternatively or additionally, the vehicles of the system 1 may be configured as an unmanned aircraft, in particular a balloon or an airspace, an unmanned water vehicle, in particular a water drone, a submarine drone or a marine drone, an unmanned land vehicle, in particular a robot vehicle, in any combination.

Each vehicle 4 and 5 has a control unit 6 for the autonomous movement within space, wherein each vehicle 4 and 5 may be controlled in real time according to a temporal sequence of positions within space. The positions of the vehicles are marker positions MP of the dynamic markers at a determined point in time, for example, MP1 at the first point in time, T1. The marker positions MP may, for example, be “global positioning system (GPS)” based, three-dimensional coordinates, this is, for example, data in the GPS Exchange Format (GPX), wherein a GPS receiver of the vehicle 4 or 5 may be used. The data in the GPX format may contain geodata, this is the geographical coordinates of magnitude, longitude and altitude. Alternatively, the data may be based on the Galileo, GLONASS, Beidou/Compass or any further satellite navigation and/or timing system or on a local or building based navigation system for the position determination of an aircraft within or outside of buildings (such as position determination by transfer of emitting signals, optical position determination systems, etc.).

Using the control unit 6 it is, hence, possible to control the vehicle 4 or 5 at a determined speed to a determined position within space or along a determined path within space. For this purpose, a drive unit 7 is accordingly controlled by the control unit 6, wherein the data regarding the respective marker positions MP may be located on a storage unit of the control unit 6.

In addition, the vehicles 4 or 5 may have a communication unit 8. The control unit 6 may in this way receive in real time the marker positions MP also from an external control device, in particular from a control centre 9 of the system 1, wherein the control centre 9 also has a communication unit 8 and may be, for example, a laptop, a tablet or any other electronic computer device, and/or it may send the current marker positions MP in real time to this external control device. By means of the control centre 9, the position within space that is to be controlled by a vehicle 4 or 5 may thus optionally be updated at any given point in time. For this purpose, the control centre 9 may have a user interface, among others, for varying the images 2 and/or 3 in real time. The communication unit 8 of the vehicle 4 or 5 may also be configured to communicate with the communication unit 8 of a further vehicle 4 or 5.

The vehicles 4 or 5 may be configured to form at least one spatial flock- or swarm-like configuration according to a formation and/or image, for example, according to a ring of the images 2 or 3, wherein the control centre 9 will exclusively communicate with a control vehicle of the flock or swarm configuration and wherein the residual vehicles of the flock or swarm configuration will communicate with the control vehicle by way of the communication units 8.

The vehicles 4 or 5 may form the dynamic markers as an entity. Alternatively or additionally, the vehicles 4 or 5 may have display means 10 in order to present and/or to improvedly present the dynamic markers. The vehicle 4 according to the first embodiment has a fluorescent screen as a display means 10, which may be illuminated by, e.g., LEDs. In addition, the vehicle may have a LASER means 11, wherein the LASER means 11 may be configured to be rotatable at least about one axis, such as about a symmetry axis 12 of the vehicle 4. The control unit 6 may be configured to control the LEDs and/or the LASER means 11. Alternatively or additionally, the LEDs and/or the LASER means may also be controlled by the control centre 9. Using the LASER means 11, there may be presented, in addition to the dynamic markers, further markings of the dynamic image 2 or 3, for example LASER lines 13 as connections between individual vehicles 4. Alternatively, the display means 10 may be composed of one or several uni- or multi-coloured LEDs and/or halogen lamp/s and/or fluorescent tube/s.

The vehicle 5 according to the second embodiment has a dynamic display as display means 10, for example, an LED, OLED or OLED monitor consisting of individually controllable pixels. The display may also be controlled by means of the control unit 6 and/or the control centre 9.

The system 1 in the first exemplary embodiment according to FIG. 1 has forty vehicles 4 according to the first embodiment. If the image 2 at the point in time T1 is moved into the image 2 at a second point in time T2, then, for example, a vehicle 4 is moved by means of the control unit 6 from a first marker position MP1 of the first image 2 to a second marker position MP2 of the second image 3. In this way, all vehicles 4 are moved, whereby in the example shown five rings in any arrangement of the image 2 are moved into the known formation of the Olympic Rings of image 3. The images 2 and 3 are exclusively presented by the vehicles 4, which form the dynamic markers, with the dashed circular lines of the rings in FIG. 1 serving only for a clearer presentation. In addition, these dashed circular lines of the rings may also be presented by means of the LASER lines 13.

The system 1 further has two portable devices 14, for example, smart phones, which are used by users 15. The portable devices 14 have a shooting unit (not depicted), such as a camera, which is configured to shoot the image 2 or 3, as well as an electronic data processing unit (not depicted). The electronic data processing unit is configured to identify the dynamic markers by way of the shots and to process the shots by way of the identified markers accordingly. The data processing unit is configured to output the processed shots to a display means 16 of the system 1, e.g., as according to FIG. 4, to a display of the portable device 14, which, as an example, may be presented as a smart phone. In this regard, the data processing unit is configured to output the shots processed by way of the identified dynamic markers of the first image 2, the second image 3 and optionally of all intermediate images that may be shot according to a shooting speed of the shooting unit.

“All intermediate images that may be shot according to a shooting speed of the shooting unit” means that, for example, the shooting unit may also shoot a film from time point T1 to time point T2, which film the data processing unit will process essentially in real time and output to the display means 16 of the system 1. The shooting speed of the shooting unit thus determines the number of images per second or the number of intermediate images from T1 to T2.

As the markers may permanently vary dynamically, the portable device 14 may determine and process not only a determined pre-defined information from the images 1 and 2 or from the markers at the point in time T1 or T2, respectively, but rather a plurality of additional items of information, which may be derived from the movement of the vehicles 4, this is, the movement of the markers.

When processing the shots, the data processing unit of the portable device 14 may be configured to superimpose, combine and/or replace the shots, in particular the identified dynamic markers, with pre-defined, in particular dynamic and/or three-dimensional, graphical elements 17 and 18. The graphical elements 17 and 18 may be located on a storage unit (not depicted) of the data processing unit of the portable device 14 and/or of the portable device 14 and/or they may be transmitted by means of a communication unit (not depicted) of the portable device 14 to the data processing unit, for example, by the control centre 9. The data processing unit is configured to output the shots thus processed to the display means 16.

Thereby, the relative positioning of the vehicles 4 to one another, this is, for example, according to the image 1 or 2, is decoded and/or encoded by the portable device 14 by means of the decoding and/or encoding technology/software best suitable for this purpose. “Decoding” in this case corresponds to the identification and determination of the relative positioning of the markers, this is, the vehicles 4, or of a code, which is presented by the relative positioning of the markers, this is, the vehicles 4 (see further below), in particular by means of the shooting unit or accordingly suitable sensor technology of the portable device 14 known to those skilled in the art. “Encoding” in this case corresponds to the enrichment of the decoded relative positioning of the markers, this is, the vehicles 4, to one another using additional information, for example, the graphical elements 17 and 18. In this regard, the portable device 14 may selectively access information, for example, from the storage unit or the internet, and it may assign or superimpose this information to/with the markers visible at the display means 16 for the shooting unit of the portable device, in particular the display of a smart phone, or it may visually replace the markers by this information.

Alternatively or additionally, the display means 16 may be configured as a device coupled to the portable device 14 or an autonomous device for the presentation of virtual reality contents, in particular as VR goggles. Alternatively or additionally, the portable device may be a laptop computer, for example, of the control centre 9, or the display means 16 of the system 1 may be a large screen or a large monitor for all users 15. Alternatively, the portable device 14 may also be configured as a laptop PC used by a user 15, a tablet PC or a smart watch, in particular in combination with VR goggles.

In addition, the data processing unit of the portable device 14 may be configured to determine, by way of the identified dynamic markers and at least one reference image, the position P of the portable device 14 within space in relation to a reference position RP of the system 1 and to adjust the processing of the shots according to the determined position P of the portable device, whereby the reference image may be located on the storage unit of the portable device 14 and/or may be transmitted from the control centre 9 to the data processing unit.

For example, two users 15 using their portable devices 14 present according to figure the image 3 at the point in time T2. One user 15 is located at the position P(RP), which has an approximately orthogonal viewing direction B to the reference position RP of the system 1, in the present case of the image 3. In this case, the data processing unit of the portable device 14 of this user 15 will identify actually five approximately circular rings, comparing these with the reference image, which consists of five circular rings. In this way, the data processing unit recognizes that the portable device 14 of this user 15 is located approximately at the position P(RP) and is configured to process and output the image to be output to the display means 16 and/or the dynamic and/or three-dimensional, graphical elements 17 and 18 to be superimposed, to be combined and/or to be replaced in relation to the viewing direction of this user 15. The rings 17 in FIG. 4 are in this case presented, for example, according to the reference image consisting of five circular rings.

A further user 15 is located at the position P(RP+α), which has a viewing direction B to the reference position RP of the system 1 at the angle α. In this case, the data processing unit of the portable device 14 of this user 15 will identify five elliptical rings, comparing these with the reference image. The data processing unit in this way recognizes that, for example, by way of the form of the ellipse, the portable device 14 of this user 15 is located approximately at the position P(RP+α) and is configured to superimpose, to combine and/or to replace the dynamic and/or three-dimensional, graphical elements 17 and 18 in relation to the viewing direction of this user 15. The rings 17 are presented in this case either as ellipses, or they are, as shown in FIG. 4, adjusted to the reference image consisting of five circular rings accordingly. In this way, there may be obtained a user-specific result or a result uniform for all users 15.

The determination above of the position P of the portable device 14 within space in relation to a reference position RP of the system 1 may be further improved if, for example, the exact position of the portable device 14 and the exact reference position RP of the system 1 are known, this is, for example, distance and height difference between portable device 14 and reference position RP.

The portable device 14 may have a user interface, for example, a touchscreen and/or mechanical input means, in particular keys, of a smart phone. By means of the user interface, a user 15 of the portable device 14 may be configured to control the control units 6 of the vehicles 4, wherein the communication unit of the portable device 14 is configured for the unilateral and/or mutual communication with the communication unit/s of the vehicles 4 and/or the control centre 9. This user 15 may in this way input, for example, via the internet or a local wireless network of the system 1, entries, this is, commands, in order to control the vehicles 4, this is the dynamic markers, by means of these commands. The commands may be transmitted directly from the portable device 14 to one, several or all respective vehicles 4 or the control centre 9. The control centre 9 may further the control commands received to one, several or all respective vehicles 4. Optionally, the control centre 9 may first process the control commands, in particular in regard to executability and/or security.

In a method according to the invention using the system 1 according to FIG. 1, in a method step A), the vehicles 4 are controlled by the control centre 9 to respectively a first marker position MP1 of the first image 2, wherein each vehicle 4 assumes its marker position MP1 at the point in time T1.

In a method step B) the vehicles 4 are then controlled by the control centre 9 to respectively a second marker position MP2 of the second image 3, wherein each vehicle 4 assumes its marker position MP2 at the point in time T2.

During the method steps A) and B), the users 15 will shoot in a method step C) using the shooting units of their portable devices 14 the first image 2, the second image 3 and optionally all intermediate images that may be shot according to a shooting speed of the shooting unit.

During and/or after the method step C), the data processing unit will identify in a method step D) the dynamic markers by way of the vehicles 4, for example, the five rings presented by the vehicles 4 at the point in time of T2, processing these shots by way of the identified dynamic markers.

During and/or after the method step D, the data processing unit superimposes, combines and/or replaces in a method step E) the processed shots with pre-defined, in particular dynamic, graphical elements 17 and 18, which are located on a storage unit of the portable device 14. Thereby, the data processing unit will replace, for example, the identified dynamic markers with the Olympic rings 17 in the five colours. In addition, the data processing unit determines, in particular animates, firework-like dynamic elements 18, which fly through the rings 17 and explode. The dynamic elements 18 may also be presented as dragons flying through the rings, wherein, for example, depending on the position P of a user 15, the dynamic elements 18, in particular the dragons, will fly directly towards a user 15 at the position P(RP), or wherein the user 15 observes these from the side at the position P(RP+α).

In a method step F), the data processing unit will output the shots processed according to the method steps D) and E) to the display means 16.

The method steps D), E) and F) may be carried out by means of a software product, in particular an app, which is located on the storage unit of the portable device 14, in particular of a smart phone, by the data processing unit of this portable device 14. Thereby, the portable device 14 may communicate with the control centre 9, for example, in order to acquire the reference image, the reference position RP, the position P of the portable device 14 and/or the pre-defined graphical elements 17 and 18.

FIG. 5 shows a system 20 according to the invention for the presentation and identification of dynamic markers of a variable geometrical image 21 within space. Essentially the same description is effective for the system 20, optionally adjusted accordingly, as for the system 1, and it is here omitted for reasons of brevity. A first image 21 is presented at a time point T, consisting, for example, of two symbols, namely a cross and a crescent. A second image is not depicted in FIG. 5. The first image 21 may alternatively present a sequence of numbers or a sequence of images. The dynamic markers are formed by the vehicles 4. Alternatively or additionally, the dynamic markers may also be formed by the vehicles 5. Alternatively, the three dynamic markers presented in FIG. 5 furthest at the bottom (two crosses and one crescent) also be formed by autonomous robot vehicles on the ground.

A first image could also be formed as a zero position of the vehicles of a system according to the invention, for example, at the control centre 9 in FIG. 5. The vehicles then would move from there to a second image, for example, the image 21 of FIG. 5.

The users 15 shoot the first image 21 using the shooting units of their portable devices 14, in particular the cameras of their smart phones. The first image 21 presents a code, wherein the data processing unit is configured to compare the shoots, in particular the identified dynamic markers, and/or the processed shots of the first image 21 with an individualized reference image, which is, for example, stored on a storage unit of the corresponding portable device 14 and which is transmitted in real time from the control centre 9 to the portable device 14. If the reference image coincides with the processed shot, the individualized graphical elements, for example, are output on the display means 16 of the system 20, in particular of the corresponding portable device 14. Thereby, the code may only be recognized, for example, by a data processing unit of a portable device 13, which means that only a portable device 14 will have the key to the code, or the code will be recognized by several or all data processing units of the system 20, wherein the same or several different individualized graphical elements 17 and 18 will be output.

With a system 20 according to the invention and/or a corresponding method, static and/or dynamic codes may be decoded by means of a photo and/or video shooting of the shooting unit of the portable device 14, wherein these codes may be assigned to visualizations or functions, for example, opening of a web link or playing a video on the portable device 14. The codes may be generated, like in “augmented reality applications” having barcodes or QR codes, by means of a coding method.

A system according to the invention and/or method may be provided in the presentation of art or information for the entertainment industry, on the occasion of public and private events as well as competitions or emergency operations. Thereby, the software product according to the invention may be transmitted to observers of the presentation, in particular via their smart phones.

1. A system for presenting and identifying markers of a geometrical image within space, the system comprising:
at least one portable device with a shooting unit, which is configured to shoot the image, and
an electronic data processing unit, which is configured to identify the markers and to process the shots by way of the identified markers, wherein the markers are configured as dynamic markers of a geometrical image variable in terrestrial space,
at least three vehicles for forming the dynamic markers, wherein each vehicle 1 is configured to be autonomously moved within space by means of a control unit, wherein the control unit of at least one vehicle is configured to move the vehicle from a first marker position of a first image to a second marker position of a second image,
wherein the data processing unit is configured to output the shots processed by way of the identified dynamic markers of the first image and of the second image, shot according to a shooting speed of the shooting unit, to a display means.

2. The system according to claim 1, wherein the data processing unit of the portable device, when processing the shots, is configured to superimpose, combine and/or replace the shots, including the identified dynamic markers, with pre-defined, dynamic and/or three-dimensional, graphical elements, wherein the graphical elements are located on a storage unit of the portable device and/or are transmitted by means of a communication unit of the portable device to the data processing unit, and wherein the data processing unit is configured to output the shots thus processed to the display means.

3. The system according to claim, wherein the system includes a control centre, wherein the control centre is configured to control the control units of the vehicles, wherein the vehicles and the control centre have communication units for the mutual communication.

4. The system according to claim 3, wherein the control centre is configured to transmit the graphical elements to the portable device.

5. The system according to claim 3, wherein the data processing unit of the portable device is configured to determine, by way of the identified dynamic markers and at least one reference image, the position of the portable device within space in relation to a reference position of the system and to adjust the processing of the shots according to the determined position of the portable device, wherein the reference image is located on a storage unit of the portable device and/or is transmitted from the control centre to the data processing unit.

6. The system according to claim 1, wherein the portable device has the display means and is configured as a device for the telecommunication and/or as a device for presenting virtual reality contents or augmented reality contents.

7. The system according to claim 1, wherein at least one of the vehicles has a vehicle equipment, selected from the following group: unmanned aircraft, a balloon or an airship, unmanned water vehicle, a submarine drone or a marine buoy, or an unmanned land vehicle.

8. The system according to claim 1, wherein the data processing unit of the portable device is configured to compare the shots, including the identified dynamic markers, and/or the processed shots of an image with a general reference image and/or with individualized reference images, including individualized codes, wherein the general reference image and/or the individualized reference images are located on a storage unit of the portable device and/or are transmitted by means of a communication unit of the portable device to the data processing unit.

9. The system according to claim 1, wherein the portable device is configured, by means of a user interface, to control the control units of the vehicles, wherein the communication unit of the portable device is configured for the unilateral and/or mutual communication with the communication unit/s of the vehicles and/or the control centre.

10. A method for presenting and identifying markers of a geometrical image within terrestrial space, shot by a shooting unit of a portable device, wherein the markers are identified by an electronic data processing unit of the portable device, wherein the markers are configured as dynamic markers of vehicles autonomously movable within space, the method comprising:
A) controlling at least three vehicles to respectively one first marker position of a first image by means of a control unit of the vehicle;
B) controlling at least one of the vehicles to a second marker position of a second image by means of the control unit;
C) during the steps A) and B), shooting the first image, the second image and all intermediate images according to a shooting speed of the shooting unit, by means of the shooting unit;
D) during and/or after the step C), identifying the dynamic markers and processing the shots by way of the identified dynamic markers by means of the data processing unit;
F) outputting the shots processed to a display means by means of the data processing unit.

11. The method according to claim 10, further comprising:
step E) during and/or after the method step D), the shots processed, including the identified dynamic markers, are superimposed, combined and/or replaced by means of the data processing unit with pre-defined, dynamic, graphical elements, wherein the graphical elements are located on a storage unit of the portable device and/or are transmitted by means of a communication unit of the portable device.

12. A non-transitory computer readable medium comprising computer executable instructions for performing the method of claim 10.

13. The non-transitory computer readable medium according to claim 12, wherein the non-transitory computer readable medium is located on a storage unit of a portable device.

14. The system according to claim 1, wherein the data processing unit is configured to output the shots processed by way of all intermediate images shot according to the shooting speed of the shooting unit.

15. The system according to claim 6, wherein the device for the telecommunication is a smart phone and the device for presenting virtual reality contents or augmented reality contents is VR goggles or AR goggles.

16. The system according to claim 7, wherein the unmanned aircraft is a drone, the unmanned water vehicle is a water drone, and the unmanned land vehicle is a robot vehicle.
